(19) United States
(12) Patent Application Publication
(10) Pub. No.: US 2006/0077199 A1
(43) Pub. Date: Apr. 13, 2006

(54) DYNAMIC LEVEL-ADJUSTMENT COMPENSATION CIRCUIT AND METHOD FOR DYNAMIC LEVEL-ADJUSTMENT COMPENSATION

(76) Inventors: Mu-Shan Liao, Changhua County (TW); Wen-Tse Tseng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,862

(22) Filed: Oct. 11, 2004

(51) Int. Cl. G09G 5/00

(52) U.S. Cl. 345/211

(57) ABSTRACT

The dynamic level-adjustment compensation circuit includes an analyzing unit, multiple gamma voltage generators and a selector. The analyzing unit is used to analyze the gray-level distribution of the dynamic image signal and output an analysis signal. Each of the gamma voltage generators producing a gamma voltage determined by a gamma characteristic curve. The selector is electrically connected to the analyzing unit and the gamma voltage generators. The selector selects one of the gamma voltage generators according to the analysis signal and the selected gamma voltage generator outputs the corresponding gamma voltage. The gray-level distribution of the dynamic image signal input to a display can be analyzed and then, determined by the analysis result, one of gamma voltage generators is selected to output a gamma voltage driving a display. Accordingly, the image quality can be improved.

### BACKGROUND OF THE INVENTION

1. Field of the Invention

The present invention relates to a compensation circuit and a method for compensation, and more particularly, to a display compensation circuit and a method for display compensation.

2. Description of Related Art

With the development of electronic technology, electronic devices are popular in our daily life, such as ATM machine, personal computer, mobile cell, television and so on. People can acquire information from an electronic device and can be aware of the state of an electronic device by means of the display of the electronic device.

Various types of displays have been developed based on the different display theories. Flat panel displays (FPD) become more popular and gradually replace cathode ray tube (CRT) displays. Flat panel displays include plasma displays, organic electro-luminescent displays (OELD), liquid crystal displays (LCD) and field emission displays.

A liquid crystal display applies a particular driving voltage, converted from an image signal, to turn the liquid crystal at a certain degree for showing images. However, the image signal and the driving voltage are not linearly related to the rotation angle of liquid crystal and the transparent rate of a pixel. A gamma revision circuit is thereby provided for the driving circuit to have a linear relationship with the rotation angle of liquid crystal or the transparent rate of a pixel.

According to the traditional gamma revision method, a digital image signal is converted into an analogy driving voltage to drive liquid crystal particles on a basis of a single gamma characteristic curve. The image signal input into a display is converted into the driving voltage according to a same gamma value, but the gamma value will not be adjusted with the change of the image signal. Therefore, the images on a relatively dark or bright background will not be clearly displayed. As a result, the conventional gamma revision method can not provide a desirable level-adjustment for dynamic image signals and an image with a better quality.

### SUMMARY OF THE INVENTION

Accordingly, one object of the present invention is to provide a dynamic level-adjustment compensation circuit, which can determine a particular driving voltage according to different image signals based on different gamma characteristic curves.

Accordingly, one object of the present invention is to provide a dynamic level-adjustment compensation method for dynamically compensating the level adjustment according to different dynamic images in order to improve the quality of images.

To achieve these and other advantages and in accordance with the purpose of the invention, the present invention provides a dynamic level-adjustment compensation circuit suited for compensating a dynamic image signal input to a display. The dynamic level-adjustment compensation circuit includes an analyzing unit, multiple gamma voltage generators and a selector. The analyzing unit is used to analyze the gray-level distribution of the dynamic image signal and output an analysis signal. Each of the gamma voltage generators produces a gamma voltage determined by a gamma characteristic curve. The selector is electrically connected to the analyzing unit and the gamma voltage generators. The selector selects one of the gamma voltage generators according to the analysis signal and the selected gamma voltage generator outputs the corresponding gamma voltage.

To achieve these and other advantages and in accordance with the purpose of the invention, the present invention provides a dynamic level-adjustment compensation method suited to compensate a dynamic image signal input to a display. The dynamic level-adjusting compensation method comprises analyzing the gray-level distribution of the dynamic image signal, outputting an analysis signal according to the analysis result, selecting a gamma characteristic curve according to the analysis signal, and outputting a gamma voltage according to the selected gamma characteristic curve.

The present invention is suited to display dynamic images. According to the gray-level distribution of the dynamic image signals in each frame time, each of the dynamic image signals can be converted into a driving voltage with a particular gamma value.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a flow chart illustrating the process flow of a dynamic level-adjustment compensation method according to an embodiment of the present invention.

FIG. 2 is a block diagram of a dynamic level-adjustment compensation circuit according to an embodiment of the present invention.

### DESCRIPTION OF THE ILLUSTRATED EMBODIMENTS

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

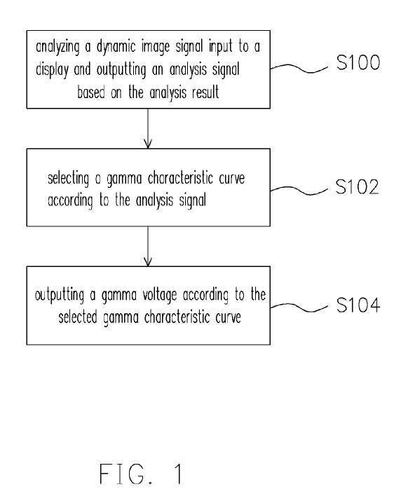

FIG. 1 is a flow chart illustrating the process flow of a dynamic level-adjusting compensation method according to an embodiment of the present invention. The dynamic level-adjustment compensation method is suited to compensate the gray-level distribution of a dynamic image signal input to a display (not shown). The dynamic image signals in different frame times have different gray-level distributions. As shown in FIG. 1, the gray-level distribution of a dynamic image signal input to a display is analyzed and then an analysis signal based on the analysis result is output, as described in step S100. An application specific integrated circuit (ASIC) can be used to analyze the dynamic image signal to acquire the gray-level distribution of the dynamic image signal.

In step S102, a gamma characteristic curve is selected according to the output analysis signal in step S100. When most gray levels of the dynamic image signal are distributed in a low level-adjustment mode in this particular frame, a gamma characteristic curve with a relatively small gamma value is selected. For example, a gamma characteristic curve with a gamma value of 2 is selected. When most gray levels of the dynamic image signal are distributed in a high level-adjustment mode, a gamma characteristic curve with a relatively high gamma value is selected. For example, a gamma characteristic curve with a gamma value of 2.4 is selected. When most gray levels of the dynamic image signal are distributed in a medium level-adjustment mode, a gamma characteristic curve with a medium gamma value is selected. For example, a gamma characteristic curve with a gamma value of 2 is selected.

In step S104, the gamma voltage according to the selected gamma characteristic curve is output by a selected gamma voltage generator constructed from a plurality of series resisters and operators.

In each frame time for displaying each image, steps S100-S104 are performed. Suitable gamma voltages corresponding to different dynamic image signals having different gray-level distributions can be output. Therefore, the image quality can be improved.

In the present invention, a gamma value of the driving voltage converted from the dynamic image signal is determined by the gray-level distributions of the image signal. The dynamic level-adjustment compensation method and the dynamic level-adjustment compensation circuit of the present invention now will be described more fully hereinafter. This invention may, however, be embodied in many different forms and should not be construed as limited to the embodiments set forth herein.

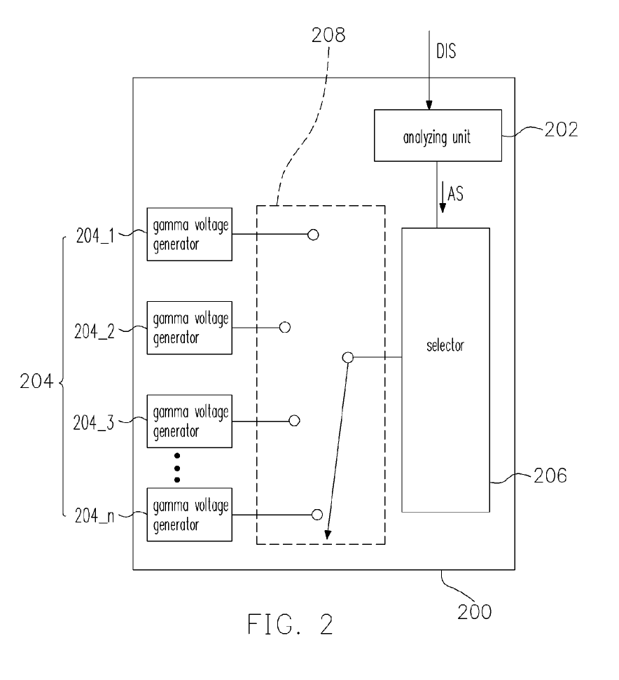

FIG. 2 is a block diagram of a dynamic level-adjusting compensation circuit according to an embodiment of the present invention. Referring to FIG. 2, a dynamic level-adjustment compensation circuit 200 provided in a display device converts a dynamic image signal (DIS) input to the display device from a digital signal to a analog signal. The converted analog signal has a linear relationship with the rotation angle of liquid crystal and the transparent rate of a pixel. The dynamic level-adjustment compensation circuit 200 includes an analyzing unit 202, multiple gamma voltage generators 204_1, 204_2, 204_3, 204_{—}n and a selector 206. The analyzing unit 202 is used to analyze the gray-level distributions of the dynamic image signals and output analysis signals (AS) based on the analysis result to the selector 206. The analyzing unit 202 may be an application specific integrated circuit (ASIC) used to analyze the gray-level distributions of the dynamic image signals in different frame times. The analyzing unit 202 may show, for example, a statistical diagram about the gray-level distributions of the dynamic image signals and may determine whether the images displayed by the dynamic image signals are relatively dark, relatively bright or medium.

The selector 206 is electrically connected to the analyzing unit 202 and the gamma voltage generators 204_1, 204_2, 204_3, and 204_{—}n. After the selector 206 receives the analysis signals (AS) output from the analyzing unit 202, the selector 206 selects one of the gamma voltage generators 204_1, 204_2, 204_3, and 204_{—}n according to the analysis signal (AS) and outputs the selected gamma voltage. For example, the gamma voltage generator 204_1 may have a gamma characteristic curve with a gamma value of 2.0; the gamma voltage generator 204_2 may have a gamma characteristic curve with a gamma value of 2.2; the gamma voltage generator 204_3 may have a gamma characteristic curve with a gamma value of 2.4. The application of the present invention is not limited to the number of the gamma voltage generators. Those skilled in the art can use whatever number of the gamma voltage generators, depending on the need in practice.

The gamma voltage generators 204 can produce different gamma voltages determined by their different gamma characteristic curves with different gamma values. Similar to the common gamma voltage generator, the gamma voltage generators 204 may be constructed from a plurality of series resisters and operators.

Multiple switch units 208 may be arranged between the selector 206 and the gamma voltage generators 204. The selector 206 controls the switch units 208 kept in an open mode or in a close mode.

For example, when the analysis signal output from the analyzing unit 202 indicates that the image displayed by the image signal is relative dark, the selector 206 can be connected to the gamma voltage generator 204_1 having a gamma characteristic curve with a gamma value of 2.0 via the switch unit 208. The gamma voltage generator 204_1 can output a gamma voltage determined by its gamma characteristic curve, leading a spectator to clearly watch the content displayed on a relatively dark image. When the analysis signal output from the analyzing unit 202 indicates that the image displayed by the image signal is relative bright, the selector 206 can be connected to the gamma voltage generator 204_3 having a gamma characteristic curve with a gamma value of 2.4 via the switch unit 208. The gamma voltage generator 204_3 can output a gamma voltage determined by its gamma characteristic curve, allowing a spectator to clearly the content displayed on a relatively bright image. When the analysis signal output from the analyzing unit 202 indicates that the image displayed by the image signal is medium, the selector 206 can be connected to the gamma voltage generator 204_2 having a gamma characteristic curve with a gamma value of 2.2 via the switch unit 208. The gamma voltage generator 204_2 can output a gamma voltage determined by its gamma characteristic curve, allowing a spectator to clearly watch the content displayed on a medium brightness image.

In the present invention, the gray-level distributions of dynamic image signals input to a display are analyzed and then determined by the analysis result. One of gamma voltage generators is selected to output a gamma voltage for driving a display. Therefore, the image quality can be improved. Moreover, the gamma voltage generators, formed with a plurality of series resisters and operators, do not increase manufacturing cost.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A dynamic level-adjustment compensation circuit suited for compensating a dynamic image signal input to a display device, wherein said dynamic image signal in different frame times has different gray-level distributions, the circuit comprising:
an analyzing unit used to analyze the gray-level distribution of said dynamic image signal and output an analysis signal according to the analysis result;
a plurality of gamma voltage generators, each of which produces a gamma voltage determined by a gamma characteristic curve; and
a selector electrically connected to said analyzing unit and said gamma voltage generators, wherein said selector is suited for selecting one of said gamma voltage generators according to said analysis signal and said selected gamma voltage generator outputs said corresponding gamma voltage.

2. The circuit of claim 1, wherein said analyzing unit comprises an application specific integrated circuit.

3. The circuit of claim 1 further comprising a plurality of switch units electrically connected to said selector and said gamma voltage generators, said selector controlling said switch units 208 kept in an open mode or in a close mode.

4. The circuit of claim 1, wherein a number of said gamma voltage generators is at least three, one of said gamma voltage generators having the gamma characteristic curve with a gamma value of 2.0, another one of said gamma voltage generators having the gamma characteristic curve with a gamma value of 2.2, the other one of said gamma voltage generators having the gamma characteristic curve with a gamma value of 2.4.

5. A dynamic level-adjustment compensation method suited to compensate a dynamic image signal input to a display, wherein said dynamic image signal in different frame periods has different gray-level distributions, the method comprising:
step (a): analyzing the gray-level distribution of said dynamic image signal and outputting an analysis signal according to an analysis result;
step (b): selecting a gamma characteristic curve according to said analysis signal; and
step (c): outputting a gamma voltage according to said selected gamma characteristic curve.

6. The method of claim 5, wherein analyzing the gray-level distribution of said dynamic image signal is performed by an application specific integrated circuit.

7. The method of claim 5, further comprising repeating steps (a), (b) and (c) in a next frame time.

8. The method of claim 5, wherein the step of selecting a gamma characteristic curve is made from three gamma characteristic curves with gamma values of 2.0, 2.2 and 2.4.
